(19) United States
(12) Patent Application Publication
(10) Pub. No.: US 2003/0056252 A1
(43) Pub. Date: Mar. 20, 2003

(54) Robot apparatus, information display system, and information display method

(76) Inventors: Osamu Ota, Tokyo (JP); Satoko Ogure, Tokyo (JP)

Correspondence Address: William S Frommer, Frommer Lawrence & Haug, 745 Fifth Avenue, New York, NY, 10151, US

(21) Appl. No.: 10/149,149

(22) PCT Filed: Oct. 11, 2001
(86) PCT No.: PCT/JP01/08952

(30) Foreign Application Priority Data
Oct. 11, 2000 (JP) 2000-311323

(51) Int. Cl. B25J 19/00

(52) U.S. Cl. 901/47

(57) ABSTRACT

In a personal computer, a robot apparatus (1) exploits the information stored in a memory card or data of a database stored in e.g., a storage device to display an original message text (110) and its translation (111), a picture (112) and a user's message 113, as a diary picture.

### TECHNICAL FIELD

This invention relates to a robot, an information displaying system, an information displaying method, a robot systems and a recording medium. More particularly, it relates to a robot apparatus formed after the outer shape of an animal, an information displaying system and an information displaying method, exploiting the robot apparatus, a robot system, and a recording medium.

### BACKGROUND ART

Recently, there has been proposed an autonomous robot apparatus, performing autonomous behavior responsive to a surrounding environment and inner states. Certain ones of the robot apparatus are formed to the outer shape of an animal, such as a dog, and are changed in feeling or instinct, responsive to the surrounding environment and inner states, to perform the behavior based on the so changed feeling or instinct. These robot apparatus are formed as pets or family members. The user may have chats or dialog with these robot apparatus.

Meanwhile, the robot apparatus has a dialog with the user by speech or movements, by taking advantage of microphones or legs they are equipped with. However, the user is unable to know the feeling of the robot apparatus. In particular, a user who is living with a robot apparatus as a pet or as a family member will necessarily eel inclined to have a dialog with the robot apparatus with speech.

### DISCLOSURE OF THE INVENTION

It is therefore an object of the present invention to provide a robot apparatus with which it is possible for a user to have a dialog over speech, an information display system and an information display method exploiting the robot apparatus, a robot system, and a recording medium.

For accomplishing the above object, the present invention provides a robot apparatus in which the information acquired is displayed in an information display device, and which includes information acquisition means for acquiring the information adapted for being demonstrated in the information display device, and information transfer means for transferring the information acquired by the information acquisition means to the information display device.

The robot apparatus, constructed as described above, acquires the information for display on the information display apparatus, by information acquisition means, and transfers the information acquired by the information acquisition means to the information display device by information transfer means.

This robot apparatus transfers the information it has acquired to e.g., an information processing device adapted for demonstrating a document on an information display unit based on the information acquired by the robot apparatus.

An information display system according to the present invention includes a robot apparatus including information acquisition means for acquiring the information and information transfer means for transferring the information acquired by the information acquisition means. The information display system also includes an information processing device for displaying a sentence in an information display unit by exploiting a sentence pattern, provided from the outset, based on the information acquired by the information acquisition means and transferred by the information transfer means.

Thus, in the information display system, the robot apparatus acquires the information from the information acquisition means and transfers the information, thus acquired by the information acquisition means, to the information display means through the information transfer means. On the other hand, the information processing device demonstrates the sentence on the information display unit, by taking advantage of sentence patterns, provided from the outset, based on the information transferred by the information transfer means and acquired by the information acquisition means.

In this information display system, a document is demonstrated on the information display unit based on the information acquired in the robot apparatus.

An information display method according to the present invention includes acquiring the information by a robot apparatus, and displaying the sentence in an information display unit of an information processing device, based on the information as acquired by the robot apparatus, by exploiting the sentence pattern provided from the outset. That is, with the present information display method, a document is demonstrated on the information display unit based on the information acquired by the robot apparatus.

A robot apparatus according to the present invention includes a robot system comprising a robot apparatus, which behaves autonomously, an information processing device for processing the information pertinent to the robot apparatus, and picture display means for displaying the contents relevant to the information processed by the information processing device.

The robot apparatus of the robot system includes information acquisition means for acquiring the activity information relevant to activities of the robot apparatus and storage means for storing the activity information acquired by the information acquisition means. The information processing means includes message pattern storage means holding a plurality of messages or sentences and diary forming means for forming a diary relevant to the robot apparatus. The picture display means demonstrates the diary formed by the diary forming means.

This robot system demonstrates a diary relevant to the robot apparatus on picture display means, based on the activity information acquired by the robot apparatus.

An information displaying method according to the present invention includes acquiring the activity information relevant to activities of a robot apparatus, behaving autonomously, by the robot apparatus, and forming a diary relevant to the robot apparatus, by an information processing device, based on a plurality of messages or sentences in message pattern storage means, holding the messages or sentences, and on the activity information, for display on picture display means. That is, with the present information display method, the diary relevant to the robot apparatus is demonstrated on the picture display means based on the activity information acquired by the robot apparatus.

Also, for accomplishing the above objects, a recording medium according to the present invention has stored thereon a program for forming a diary relevant to an autonomously behaving robot apparatus from the activity information relevant to activities of the robot apparatus and from plural messages or sentences.

Other objects, features and advantages of the present invention will become more apparent from reading the embodiments of the present invention as shown in the drawings.

### BRIEF DESCRIPTION OF THE DRAWINGS

FIG. 1 is a perspective view showing the appearance of a robot apparatus embodying the present invention.

FIG. 2 is a block diagram showing a circuit structure of the robot apparatus.

FIG. 3 is a block diagram showing a software structure of the robot apparatus.

FIG. 4 is a block diagram showing an application layer in the software structure of the robot apparatus.

FIG. 5 is a block diagram showing the structure of an application layer in the software structure of the robot apparatus.

FIG. 6 is a block diagram showing the structure of a behavioral model library of the application layer.

FIG. 7 illustrates a finite probability automaton as the information for behavior decision for the robot apparatus.

FIG. 8 shows a status transition table provided for each node of the finite probability automaton.

FIG. 9 is a perspective view showing a system configuration embodying the present invention.

FIG. 10 shows a diary display picture.

FIG. 11 shows the language given as examples as being used in the robot world.

FIG. 12 shows the former half of a specified instance of input semantics.

FIG. 13 shows the latter half of the specified instance of the input semantics.

FIG. 14 shows the former half of a specified instance of output semantics.

FIG. 15 shows a mid portion of the specified instance of the output semantics.

FIG. 16 shows the latter half of the specified instance of the output semantics.

FIG. 17 is a flowchart showing a sequence of process steps of acquiring a picture for imaging based on feeling parameter values.

FIG. 18 shows data of a picture for imaging put into order based on the feeling parameter values.

FIG. 19 shows another typical picture demonstrated on a diary display picture.

FIG. 20 shows a diary display picture demonstrated on a diary display picture.

FIG. 21 shows another typical message of a character.

### BEST MODE FOR CARRYING OUT THE INVENTION

Referring to the drawings, a preferred embodiment of the present invention is explained in detail. This embodiment is directed to an autonomous robot apparatus which behaves autonomously responsive to surrounding environments and to inner states. The robot apparatus 1 has the function of realizing a diary function which is booted on an information processing apparatus, such as a personal computer.

In the present embodiment, the structure of the robot apparatus is first explained and subsequently the diary function exploiting the robot apparatus is explained in detail.

(1) Structure of Robot Apparatus of the Present Embodiment

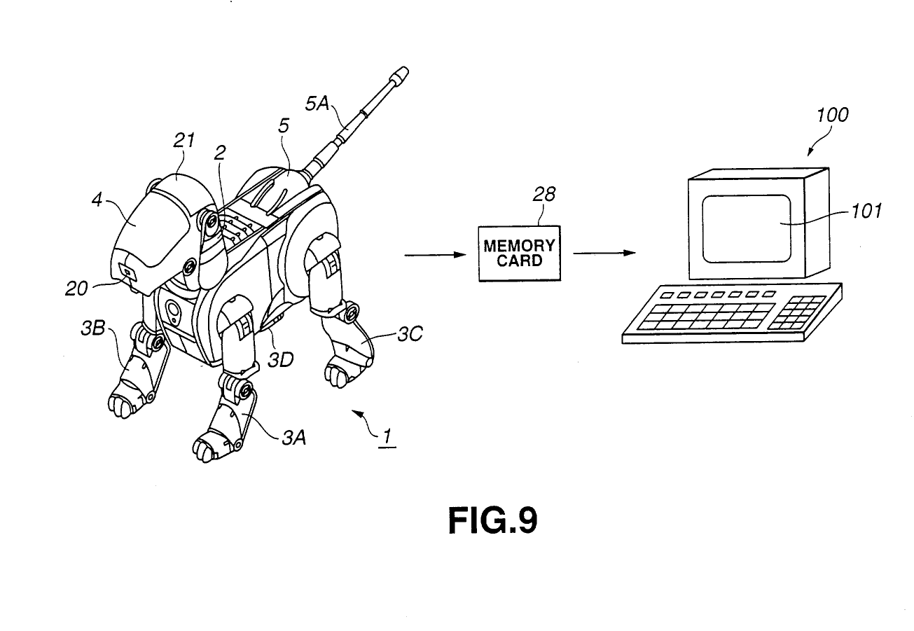

As shown in FIG. 9, the robot apparatus is a so-called pet robot, simulating an animal, such as a ‘dog’, and is constructed by leg units 3A, 3B, 3C and 3D, connected on the front and rear sides on the left and right sides of a trunk unit 2, and by a head unit 4 and a tail unit 5, connected to the front and rear ends of the trunk unit 2, respectively.

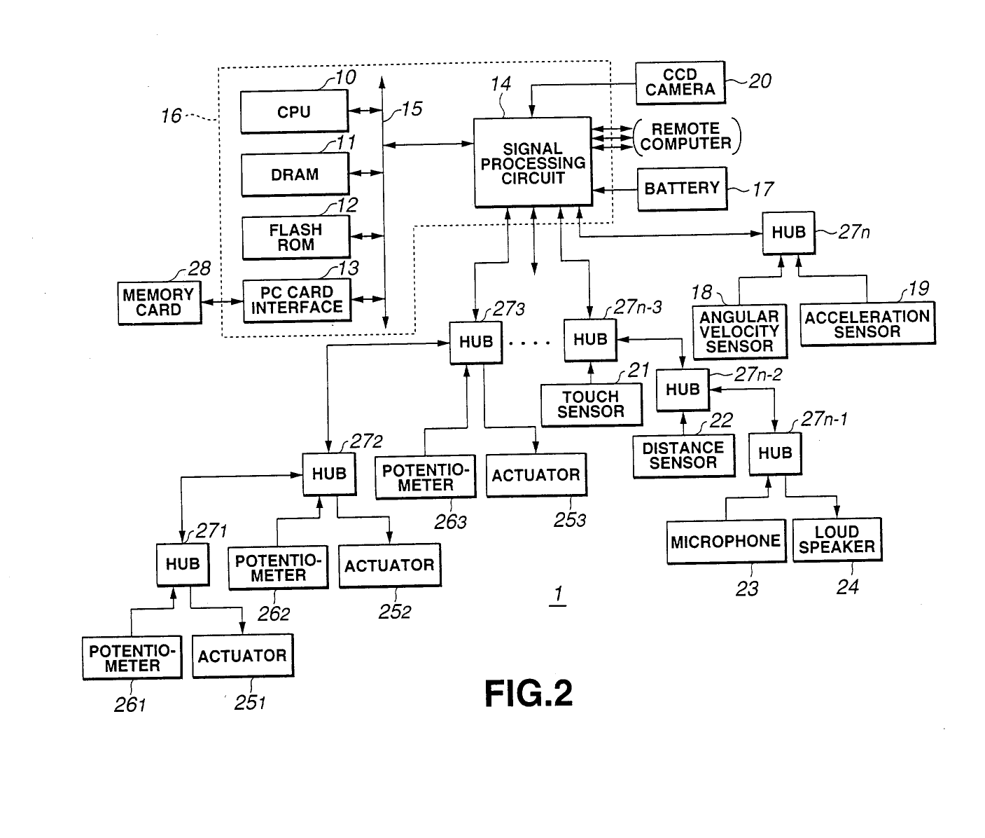

Referring to FIG. 2, the trunk unit 2 includes a controller unit 16, comprised of an interconnection over an internal bus 15 of a CPU (central processing unit) 10, a DRAM (dynamic random access memory) 11, a flash ROM (read-only memory) 12, a PC (personal computer) card interface circuit 13 and a signal processing circuit 14, and a battery 17 as a power supply for the robot apparatus 1. In the trunk unit 2 are also housed an angular velocity sensor 18 and an acceleration sensor 19 for detecting the posture and the acceleration of movement of the robot apparatus 1.

On tile head unit 4, there are mounted, in position, an image pickup device 20, such as a CCD (charge coupled device) camera for imaging an outside state, a touch sensor 21, for detecting the pressure resulting from a physical action, such as ‘stroking’ or ‘patting’ from the user, a distance sensor 22 for measuring the distance to an object positioned ahead, a microphone 23 for collecting the external sound, a loudspeaker 24 for outputting the sound, like whining, and LEDs (light emitting diodes)equivalent to the ‘eyes’ of the robot apparatus 1.

The joint portions of the leg units 3A to 3D, connecting portions of the leg units 3A to 3D and the trunk unit 2, connecting portions of the head unit 4 and the trunk unit 2 and the connecting portion of a tail 5A of the tail unit 5 are provided with a number of actuators 25₁ to 25ₙ and potentiometers 26₁ to 26ₙ corresponding to the number of the degrees of freedom. For example, the actuators 25₁ to 25ₙ include servo motors. The leg units 3A to 3D are controlled by the driving of the servo motors to transfer to a targeted posture or movement.

The sensors, such as the angular velocity sensor 18, acceleration sensor 19, touch sensor 21, floor contact sensors 23R/L, posture sensor 24, distance sensor 25, microphone 26, distance sensor 22, microphone 23, loudspeaker 24 and the potentiometers 25₁ to 25ₙ are connected via associated hubs 27₁ to 27ₙ to the signal processing circuit 14 of the controller 16, while the imaging device 20 and the battery 17 are connected directly to the signal processing circuit 14.

The signal processing circuit 14 sequentially captures sensor data, picture data or speech data, furnished from the above-mentioned respective sensors, to cause the data to be sequentially stored over internal bus 15 in preset locations in the DRAM 11. In addition, the signal processing circuit 14 sequentially captures residual battery capacity data indicating the residual battery capacity supplied from the battery 17 to store the data thus captured in preset locations in the DRAM 11.

The respective sensor data, picture data, speech data and the residual battery capacity data, thus stored in the DRAM 11, are subsequently utilized when the CPU 10 performs operational control of the robot apparatus 1.

In actuality, in an initial stage of power up of the robot apparatus 1, the CPU 10 reads out a memory card 28 loaded in a PC card slot, not shown, of the trunk unit 2, or a control program stored in the flash ROM 12, either directly or through a PC card interface circuit 13, for storage in the DRAM 11.

The CPU 10 then checks its own status and surrounding statuses, and the possible presence of commands or actions from the user, based on the sensor data, picture data, speech data or residual battery capacity data, sequentially stored from the signal processing circuit 14 to the DRAM 11.

The CPU 10 also determines the next ensuing actions, based on the verified results and on the control program stored in the DRAM 11, while driving the actuators 25₁ to 25ₙ, as necessary, based on the so determined results, to produce behaviors, such as swinging the head unit 4 in the up-and-down direction or in the left-and-right direction, or moving the leg units 3A to 3D for walking or jumping.

The CPU 10 generates speech data as necessary and sends the so generated data through the signal processing circuit 14 as speech signals to the loudspeaker 24 to output the speech derived from the speech signals to outside or turns on/off or flicker the LEDs.

In this manner, the present robot apparatus 1 is able to behave autonomously responsive to its own status and surrounding statuses, or to commands or actions from the user.

(2) Software Structure of Control Program

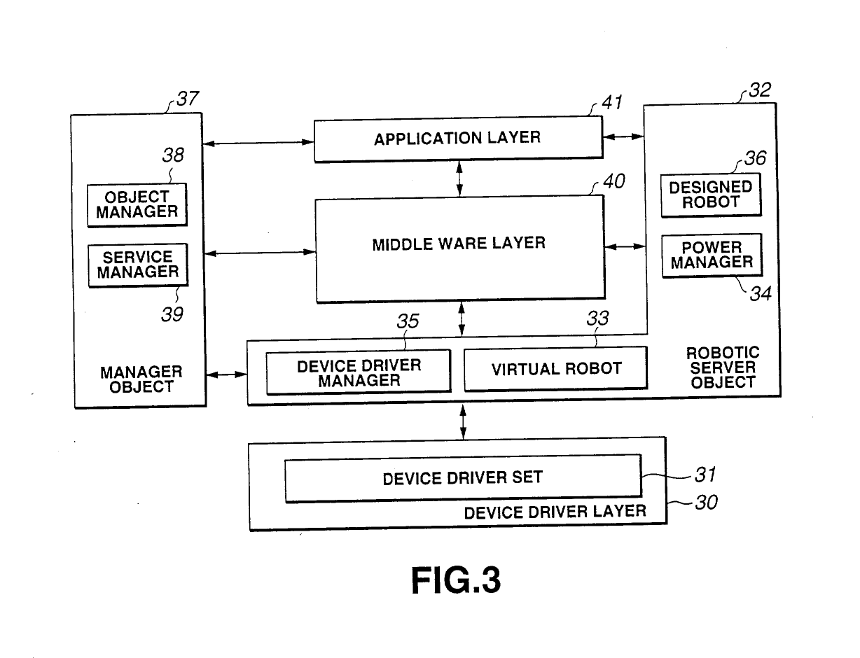

FIG. 3 shows the software structure of the above-mentioned control program in the robot apparatus 1. In FIG. 3, a device driver layer 30 is positioned in the lowermost layer of the control program, and is formed as a device driver set 31 made up by plural device drivers. Each device driver is an object allowed to directly access the hardware used in a routine computer, such as an image pickup device 20 (FIG. 2) or a timer, and performs processing responsive to interruption from an associated hardware.

A robotics server object 32 is made up by a virtual robot 33, a power manager 34, comprised of a set of software items responsible for switching between power sources, a device driver manager 35, comprised of a set of software items, supervising various other device drivers, and a designed robot 36, comprised of a set of software items supervising the mechanism of the robot apparatus 1. The virtual robot 33, located in the lowermost layer of the device driver layer 30, is comprised of a set of software items furnishing an interface for accessing the hardware items, including the above-mentioned various sensors and actuators 25₁ to 25ₙ.

A manager object 37 is made up by an object manager 38 and a service manager 39. The object manager 38 is a set of software items supervising the booting and the end of respective software items included in the robotics server object 32, a middle ware layer 40 and an application layer 41, while the service manager 39 is a set of software items supervising the connection to respective objects based on the information on the connection among respective objects stated in a connection file stored in a memory card 28 (FIG. 2).

The middle ware layer 40 is positioned as an upper layer of the robotics server object 32, and is made up by a set of software items providing basic functions of the robot apparatus 1, such as picture processing or speech processing. The application layer 41 is located as an upper layer of the middle ware layer 40, and is a set of software items for deciding on the behavior of the robot apparatus 1 based on the results of the processing by the software items making up the middle ware layer 40.

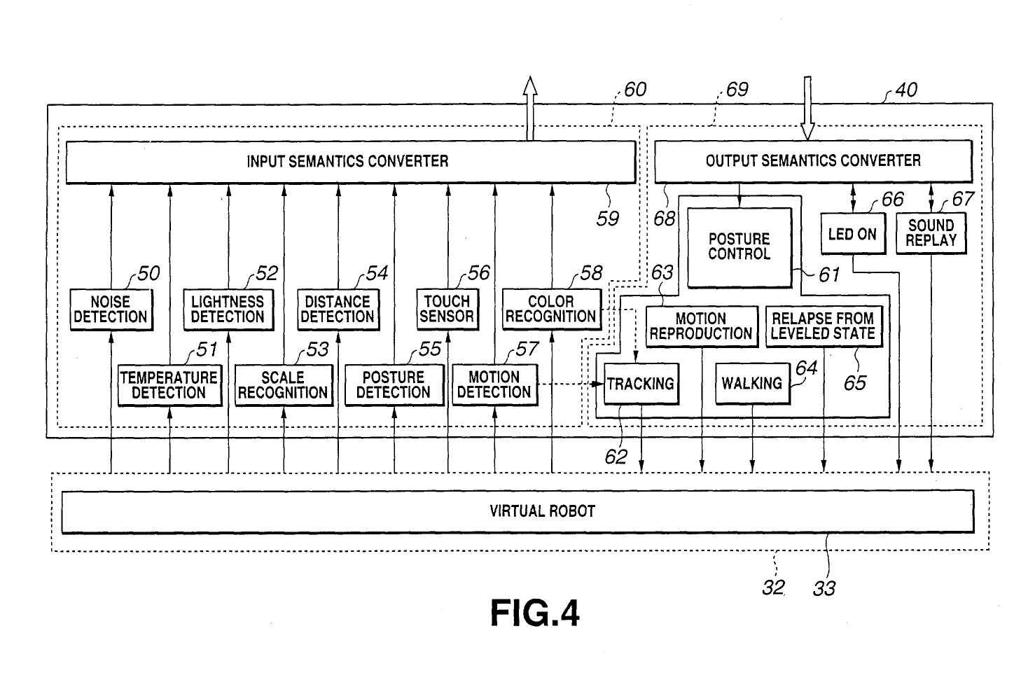

FIG. 4 shows specified software structures of the middle ware layer 40 and the application layer 41.

In the above explanation, it is assumed that a signal processing module 53 for scale recognition or a signal processing module 58 for color recognition, responsible for picture or speech processing, is provided in the middle ware layer 40. Alternatively, these functions may be provided in the application layer 41.

Referring to FIG. 4, the middle ware layer 40 is made up by a recognition system 60, having signal processing modules 50 to 58 for noise-, temperature- or lightness detection, sound scale recognition, distance- or posture detection, for a touch sensor, for motion detection and for color recognition, and an input semantics converter module 68, and by an outputting system 69, having an output semantics converter module 68 and signal processing modules 61 to 67 for posture management, tracking, motion reproduction, walking, restoration from the falldown state, LED lighting and for sound reproduction.

The signal processing modules 50 to 58 of the recognition system 60 captures relevant data from the sensor data, picture data and the speech data, read out by the virtual robot 33 of the robotics server object 32 from the DRAM 11 (FIG. 2) to process the data and routes the processed results to the input semantics converter module 59. It is noted that the virtual robot 33 is constructed as a component for exchanging or converting signals in accordance with a preset communication protocol.

The input semantics converter module 59 recognizes the own status, the surrounding status, user's commands or actions, such as ‘annoying’, ‘sultry’, ‘light’, ‘a ball has been detected’, ‘falldown is detected’, ‘stroked’, ‘patted’, ‘do-mi-so scale has been heard’, ‘a moving object has been detected’, or ‘an obstacle has been detected’ to output the results of recognition to the application layer 41 (FIG. 3).

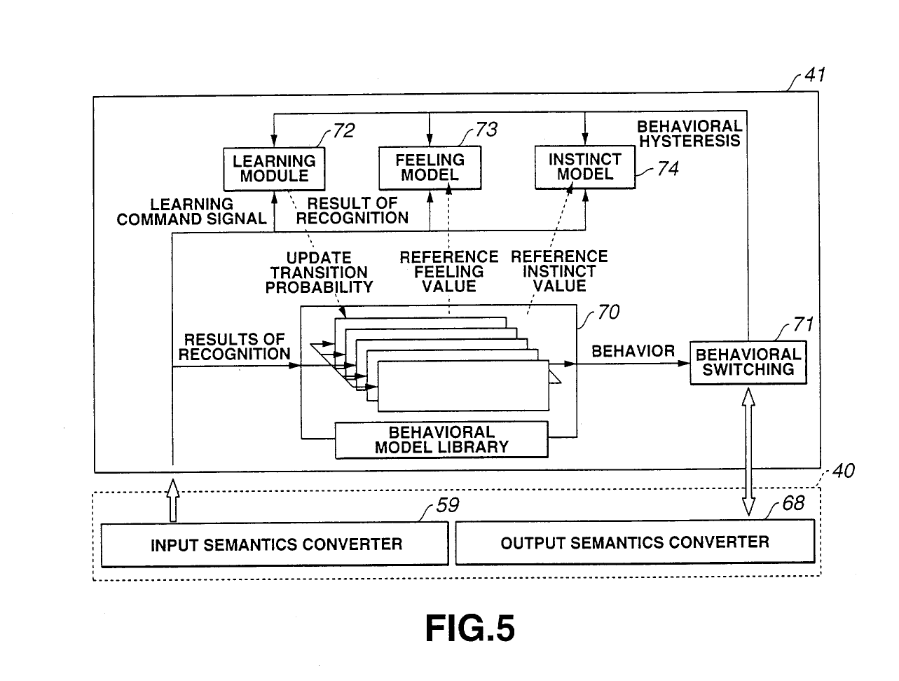

The application layer 41 is made up by five modules, namely a behavioral model library 70, a behavioral switching module 71, a learning module 72, a feeling model 73 and an instinct model 74, as shown in FIG. 5.

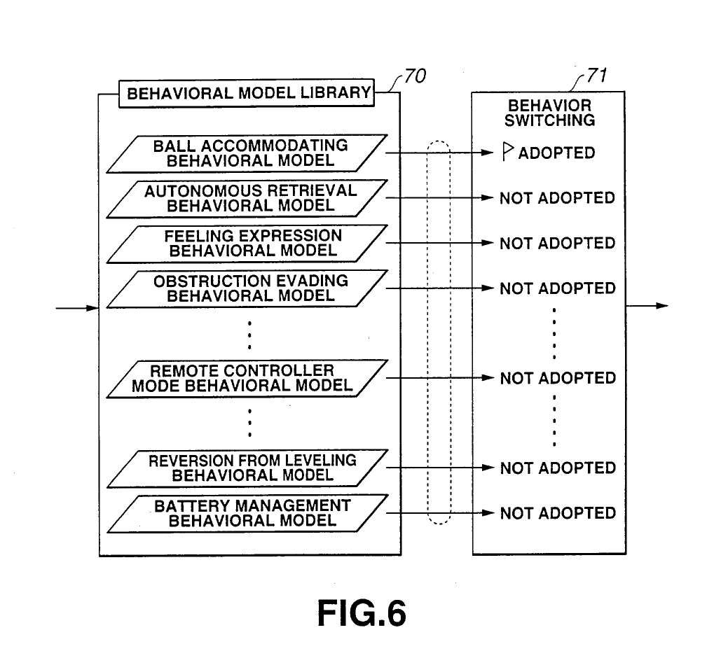

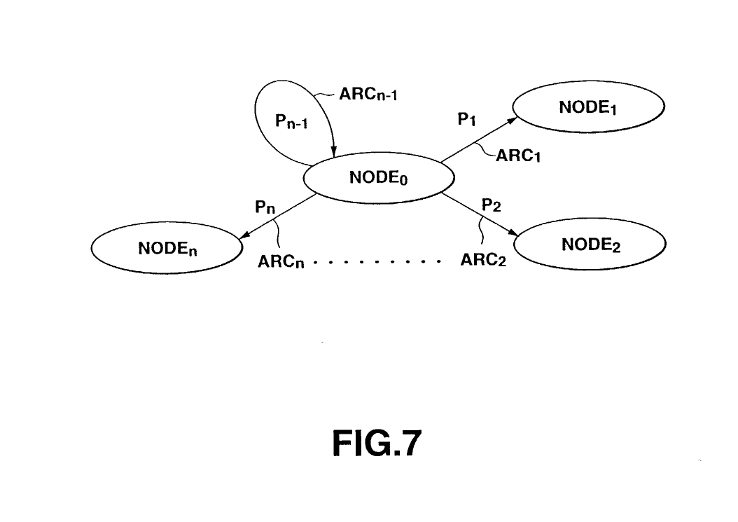

In the behavioral model library 70 there are provided respective independent behavioral models 70₁ to 70ₙ in association with plural pre-selected condition items, such as ‘residual battery capacity is small’, ‘restoration from the falldown state’, ‘an obstacle is to be evaded’, ‘the feeling is to be expressed’ or ‘a ball has been detected’, as shown in FIG. 6.

When the results of recognition are provided from the input semantics converter module 59 or a preset time has elapsed as from the time the last results of recognition were provided, the behavioral models 70₁ to 70ₙ decide on the next behaviors, as they refer to parameter values of the emotion as held by the feeling model 73 and to parameter values of the corresponding desires as held by the instinct model 74, to send the results of decision to the behavioral switching module 71.

In the present embodiment, the behavioral models 70₁ to 70ₙ use an algorithm, termed finite probability automaton, as a technique of deciding on the next behavior. This algorithm probabilistically determines from which one of the nodes (states) NODE₀ to NODEₙ to which one of these nodes NODE₀ to NODEₙ transition is to be made, based on the values of the transition probability P₁ to Pₙ as set for the arcs ARC₁ to ARCₙ₁ interconnecting the respective nodes NODE₀ to NODEₙ.

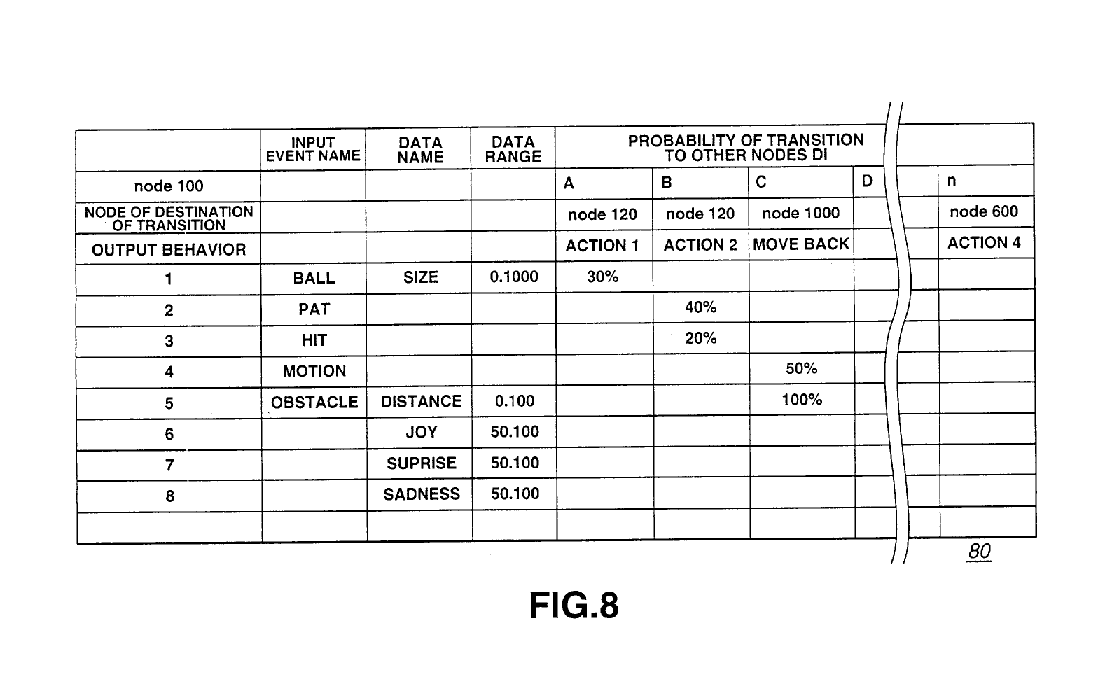

Specifically, each of the behavioral models 70₁ to 70ₙ includes a status transition table 80, shown in FIG. 8, for each of the nodes NODE₀ to NODEₙ, forming the own behavioral models 70₁ to 70ₙ, in association with these nodes NODE₀ to NODEₙ.

In the status transition table 80, input events (results of recognition), as the conditions for transition in the nodes NODE₀ to NODEₙ, are listed in the column of the ‘input event name’, in the priority order, and further conditions for the transition condition are stated in associated rows of the columns ‘data name’ and ‘data range’.

Thus, in the node NODE₁₀₀, shown in the status transition table 80 of FIG. 8, given the results of recognition ‘ball has been detected’ (BALL), the ball size (SIZE) being ‘from 0 to 1000’, as given along with the results of recognition, represents a condition for transition to another node. Similarly, given the results of recognition ‘an obstacle has been detected’ (OBSTACLE), the distance (DISTANCE) to the obstacle being in a range ‘from 0 to 100’, as given along with the results of recognition, represents a condition for transition to another node.

Also, in the present node NODE₁₀₀, if no results of recognition are input, but any one of the parameter values ‘joy’ (JOY), surprise (SURPRISE) or ‘sadness’ (SADNESS) among the parameter values of the respective emotion and desires, as held in the feeling model 73, among the parameter values periodically referenced by the behavioral models 70₁ to 70ₙ, is in a range between ‘50 and 100’, transition may be made to another node.

Moreover, in the status transition table 80, the node names to which transition can be made from the node NODE₀ to NODEₙ are shown in the row ‘nodes of destination of transition’ in the column ‘probability of transition to other nodes’. Additionally, the probability of the transition to other nodes NODE₀ to NODEₙ, enabled when all conditions stated in the columns ‘input event name’, ‘data name’ and ‘data range’ are met, is entered in corresponding locations in the column ‘probability of transition to other nodes’. The behaviors to be output on the occasion of transition to the nodes NODE₀ to NODEₙ are indicated in the row ‘output behavior’ in the column ‘probability of transition to other nodes’. Meanwhile, the sum of the probability values of each row in the column ‘probability of transition to other nodes’ is 100%.

Thus, in the node NODE₁₀₀ represented by the status transition table 80 of FIG. 8, given the results of recognition that ‘the ball has been detected’ and that the size (SIZE) of the ball is in a range from ‘0 to 1000’, transition to the ‘node NODE₁₂₀ (node 120)’ can be made with the probability of 30%, and the behavior ‘ACTION 1’ is then output.

In each of the behavioral models 70₁ to 70ₙ, a plural number of the sets of the nodes NODE₀ to NODEₙ, each stated as this status transition table 80, are concatenated together, such that, given the results of recognition from the input semantics converter module 59, the next behavior is probabilistically determined by exploiting the status transition tables of the NODE₀ to NODEₙ and the results of the decision are output to the behavioral switching module 71.

The behavioral switching module 71, shown in FIG. 5, sends to the output semantics converter module 68 of the middle ware layer 40 a command to select the behavior output from one of the behavioral models 70₁ to 70ₙ, having a preset high priority order, among the behaviors output from the respective behavioral models 70₁ to 70ₙ of the behavioral model library 70, and to execute the behavior. This command is referred to below as a behavioral command. In the present embodiment, the order of priority of a given one of the behavioral models 70₁ to 70ₙ shown in FIG. 6 is the higher the lower the rank of the behavioral model in question in FIG. 6.

The behavioral switching module 71 notifies the learning module 72, feeling model 73 and the instinct model 74 of the effect of the termination of the behavior, based on the behavior completion information afforded from the output semantics converter module 68 after the end of the behavior.

The learning module 72 is fed with the results of recognition of the instructions received as an action from a user, such as ‘patting’ or ‘stroking’, from among the results of recognition provided from the output semantics converter module 68.

The learning module 72 changes the probability of transition of the behavioral models 70₁ to 70ₙ in the behavioral model library 70, based on the results of recognition and on the notification from the behavioral switching module 71, such that, when the action is ‘patting’ (‘scolding’) or ‘stroking’ (‘praising’), the probability of occurrence of the behavior in question will be increased or decreased, respectively.

On the other hand, the feeling model 73 is holding parameters representing the intensity of each of the six emotion types, namely joy (JOY), sadness (SADNESS), anger (ANGER), surprise (SURPRISE), disgust (DISGUST) and fear (FEAR). The feeling model 73 periodically updates the parameter values of these emotion types, based on the particular results of recognition provided by the input semantics converter module 59, such as ‘patted’ or ‘strolled’, time elapsed and on the notification from the behavioral switching module 71. This updating is that of data on the memory card 28. Thus, the latest parameter values of the various emotion types of the robot apparatus 1 are stored in the memory card 28. Specifically, the parameter values are written in this case on the memory card 28 by the CPU 10. This is implemented as one of the functions of the CPU 10 of writing the parameters acquired by the information acquisition function in the memory card 28. The same may be said of the instinct model 74 which will be explained subsequently. The CPU 10 thus causes the information acquired by the information acquisition function to be stored in the memory card 28.

Specifically, the feeling model 73 calculates a parameter value E[t+1] of the current emotion type for the next period in accordance with the following equation (1):

E[t+1]=E[t]+ke×ΔE[t] (1)

where ΔE[t] in the amount of variation of the emotion type as calculated by a preset equation based on, for example, the results of recognition provided by the input semantics converter module 59, the behavior of the robot apparatus 1 at the pertinent time or on the time elapsed as from the previous updating event, E[t] is the current parameter value of the emotional type and ke is a coefficient representing the sensitivity of the emotion type. The feeling model 73 substitutes the so calculated value for the current parameter value E[t] of the emotion type to update the parameter value of the emotion type. In similar manner, the feeling model 73 updates the parameter values of the totality of the emotion types.

Which effect the respective results of recognition and the notification from the output semantics converter module 68 will have on the variation of the parameter values of the respective emotion types ΔE[t] is predetermined, such that the results of recognition ‘patted’ significantly affects the amount of variation ΔE[t] of the parameter value of the emotion type ‘anger’, while the results of recognition ‘patted’ significantly affects the amount of variation ΔE[t] of the parameter value of the emotion type ‘joy’.

The notification from the output semantics converter module 68 is the so-called behavior feedback information (behavior end information) and the information concerning the results of occurrence of the behavior. The feeling model 73 also changes the feeling based on this information. For example, the feeling level of anger may be lowered by the act of ‘barking’. Meanwhile, the notification from the output semantics converter module 68 is also input to the learning module 72, which then changes the corresponding transition probability of the behavioral models 70₁ to 70ₙ based on this notification.

Meanwhile, the feedback of the results of the behavior may be made by an output of the behavioral switching module 71 (behavior seasoned with the feeling).

On the other hand, the instinct model 74 holds the parameters, representing the intensity of five reciprocally independent desires, namely ‘desire for exercise’ ‘desire for affection’, ‘appetite’, ‘curiosity’ and ‘desire for sleep’. The instinct model 74 periodically updates the parameter values of these desires, based on the results of recognition provided from the input semantics converter module 59, time elapsed and on the notification from the behavioral switching module 71. This updating is that on the memory card 28. As a result, the latest parameter values of the various desires of the robot apparatus 1 are stored in the memory card 28.

Specifically, as concerns the ‘desire for exercise’, ‘desire for affection’ and ‘curiosity’, the instinct model 74 calculates, at a preset period, the parameter value I [k+1] of these desires at the next period, using the following equation (2):

I[k+1]=I[k]+ki×ΔI[k] (2)

where ΔI[k] is the amount of variation of the desire in question at a pertinent time as calculated by a preset equation based on the results of recognition, time elapsed and the notification of the output semantics converter module 68, I[k] is the current parameter value of the desire and ki is the coefficient representing the sensitivity of the desire in question, and substitutes the calculated results for the current parameter value I[k] to update the parameter value of the desire. The instinct model 74 updates the parameter values of the respective desires except the ‘appetite’.

The effect of the results of recognition and the notification from the output semantics converter module 68 on the amount of variation ΔI[k] of the parameter values of the respective desires is predetermined, such that, for example, the notification from the output semantics converter module 68 significantly affects the amount of variation ΔI[k] of the parameter values of ‘fatigue’.

In the present embodiment, the parameters of the respective emotion types and the respective desires (instincts) are varied in a range from 0 to 100, while the values of the coefficients ke and ki are also set individually for the respective emotion types and for respective desires.

The output semantics converter module 68 of the middle ware layer 40 sends abstract behavioral commands, such as ‘go ahead’, ‘joy’, ‘cry’, or ‘tracking (track a ball)’, provided by the behavioral switching module 71 of the application layer 41, as described above, to the signal processing modules 61 to 67 of the output system 69, as shown in FIG. 4.

Given a command for a behavior, the signal processing modules 61 to 67 generates servo command values to be supplied to the associated actuators 25₁ to 25ₙ (FIG. 2) to execute the behavior, speech data of the sound to be output from the loudspeaker 24 (FIG. 2) or driving data to be supplied to the LED of the ‘eye’ or to the ‘tail’, based on the behavioral command, and send these data through the virtual robot 33 of the robotics server object 32 and the signal processing circuit 14 (FIG. 2) in this order to the associated actuators 25₁ to 25ₙ, loudspeaker 24 or to the LED.

In this manner, the robot apparatus 1 is able to perform an autonomous behavior, based on the control program, responsive to its own inner state, surrounding state (exterior state) or to the command or action from the user.

(3) Diary Function

(3-1) System

The diary (DIARY) function is realized with the robot apparatus 1. In actuality, in the diary function, the information which the robot apparatus 1 has stored in the memory card 28 is referenced, and the diary retained to be made by the robot apparatus is demonstrated in an information processing apparatus, such as a personal computer. Specifically, the system which implements this diary function is constructed as shown in FIG. 9. In this system, the memory card 28, having stored therein the variegated information which is based on the activities of the robot apparatus 1, such as robot activity information, is loaded on the personal computer 100. Meanwhile, the information may be transmitted over a radio route without the intermediary of the memory card. In the personal computer 100, a diary retained to be prepared by the robot apparatus is demonstrated on a monitor 101, based on the information stored in the so loaded memory card 28. The personal computer 100 operates as an information processing unit which, based on the information (such as activity information) stored in the memory card 28 as information transmission means, displays the sentences of e.g. a diary on the monitor 101, as picture display means, by exploiting the sentences or message patterns provided from the outset. In the personal computer 100, there is stored a program for formulating e.g. a diary based on the activity information, sentences or message patterns.

(3-2) Information to be Displayed

The information to lie displayed on the monitor 101 of the personal computer 100 for realizing the diary function may be enumerated by the sentences written by the robot apparatus (original text with translation), a photographed image (such as one image), a character and a character's comment, a user's comment, date (day of the month, month of the year and year for to-day) and a calendar, as shown by the following Table:

information to be displayed (diary contents)

sentences written by the robot apparatus (original text with translation), a
photographed image(such as one image), a character and a character's
comment, a user's comment, date (day of the month, month of the year
and year for to-day) and a calendar

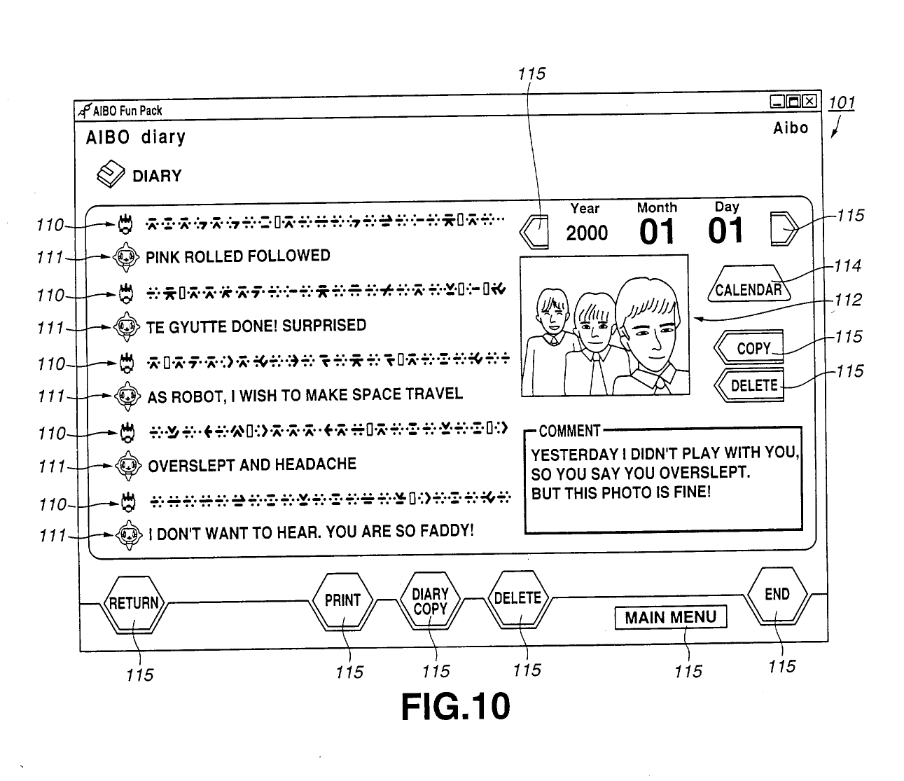

The above information is demonstrated on the monitor 101 as a diary type picture, referred to below as a diary picture. Specifically, the diary picture as shown for example in FIG. 10 is demonstrated on the monitor 101. On the monitor 101, an original text 110 by the robot apparatus 1 with translation 111, a photographed image 112 and a user's comment 113 etc are demonstrated, as shown in FIG. 10 showing a specified example. On the monitor 101 are also demonstrated icons for permitting execution of preset functions. For example, a calendar dialog is demonstrated on selection of an icon 114 of the ‘calendar’, whereby the date may be specified to check the diary. Specifically, by selecting the icon 114 of the ‘calendar’, the date where the diary is present may be checked on the calendar.

Such demonstration of the diary picture on the monitor 101 may, for example, be made by execution of an application software. For example, in the personal computer 100, the diary picture is output on the monitor 101, on execution of the application software, stored on the memory card 28, by exploiting the information acquired on the robot apparatus 1, as shown in FIG. 10.

Moreover, in the robot apparatus 1, the picture acquired by the image pickup device 20 is stored as a still image on the memory card 28 at a preset timing. The timing for storing the still image in the memory card 28 has, as a condition, the emotion type parameter having reached a preset value, as will be explained subsequently.

The still picture stored in the memory card 28 may be included in the diary picture for outputting to the monitor 101, as shown in FIG. 10. In this case, the diary is just like a pictorial diary.

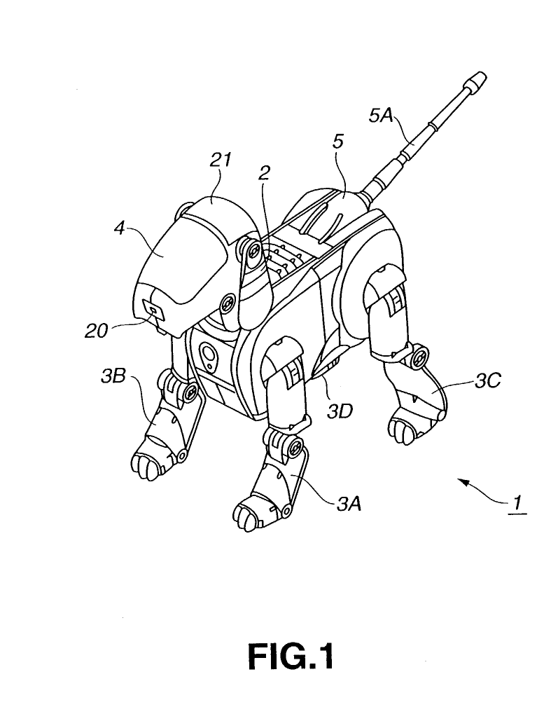

For example, the diary picture is provided as the picture information, provided at the outset as a preset format. The information or data, acquired in the robot apparatus 1, is pasted at a preset position of the diary picture of the format, and ultimately the diary picture shown in FIG. 1 0 is displayed on the monitor 101.

The diary picture may also be constructed as a so-called browser which is a browser software. This enables the user to browse the diary picture, without using the specified so-called PC application software.

(3-3) Pattern of Displayed Message

On the monitor 101 are demonstrated various messages in the diary picture. The message pattern are stored in, for example, a storage unit, such as a hard disc (HD) of the personal computer 100. In the personal computer 100, the message pattern is selected, based on the data acquired in the robot apparatus 1, so as to be displayed at desired positions in the diary picture as being the speech uttered by the robot apparatus. At this time, the message in a virtual language commonly used in the robot's world is displayed, along with the translation in e.g., Japanese. In the present embodiment, five messages, each comprised of the original message 110 and its translation 111, arrayed in conjunction with each other, are displayed.

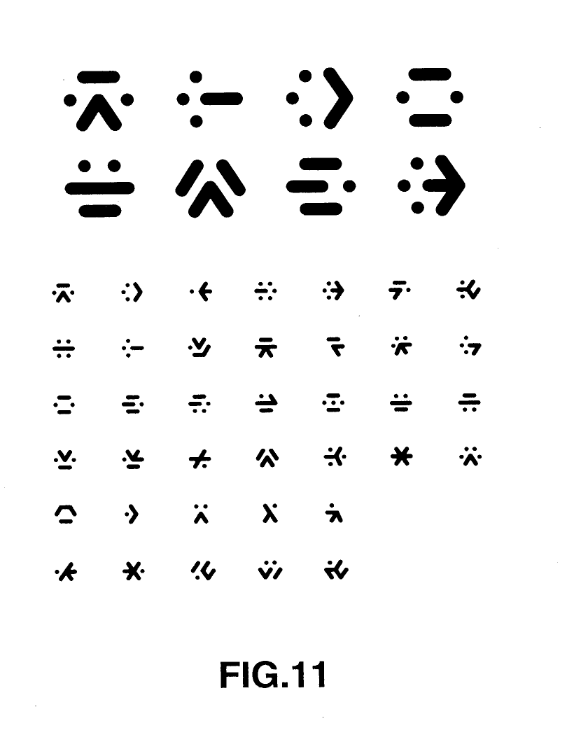

The original message, commonly used in the robot's world, are stored in a memory of the personal computer 100, as e.g., a table, in one-for-one correspondence, whereby the original message 110 and its translation 111 are displayed as messages. The language shown in FIG. 11 is assorted with the translation in e.g., Japanese or alphabets and arranged as the table.

These message patterns are classified in plural groups and stored in this form. For example, the message patterns are classified into groups shown in the following

TABLE

| priority order | group classification in meeting with display messages |
|---|---|
| 1 | birthday-related message |
| 2 | anniversary-related message |
| 3 | dates of growth stages |
| 4 | input/output information (interpretative information) |
| 5 | type changes in an adult stage |
| 6 | growth and instinct |
| 7 | others |

As may be seen from this table, the messages are classified into those related with the birthday, anniversary, dates of growth, input/output information, type changes in the adult stage, growth and instinct, and with others. The priority order is associated with the respective groups.

These messages, thus grouped, are selected on the condition that the contents to be displayed exist, that is that the original data is present in the memory card 28 and that the priority order of the data is to be followed.

Since the number of the messages that can be displayed in the diary picture is a finite number, herein five, the group is selected based on the priority order attached to the data to display one of the messages in the selected group. The priority order is determined depending on e.g., the occurrence frequency. For a given person, the birthday is usually once a year, whereas the anniversary usually occurs several times a year, so the birthday-related message is to be higher in priority order than the anniversary-related message. Thus, group selection is made as follows:

If, for example, the birthday-related message is topmost in the priority order, however, date used as the birthday-related message to be displayed is not found in the memory card 28, the anniversary-related message, which ranks second in the priority order, is selected, in case data to be used as the anniversary-related message to be displayed is found in the memory card 28. Based on this data, the message provided as the anniversary-related message is displayed.

In each group, there are plural sorts of messages to the same tenor, depending on the data stored in the memory card 28. One of these messages may be selected at random. The messages provided may be in variable in their entirety, or only specified portions thereof may be variable, depending on data stored in the memory card 28. For example, the variable portions may be relative with the subject of the message. Specified examples of the messages provided from group to group are hereinafter explained.

(3-3-1) Messages of the Birthday-related Group

The birthday-related group is selected when there is birthday data. As typical of the birthday-related messages is a message which reads: ‘To-day is a birthday of (variable portion)’. In the birthday-related group, there are plural sorts of the messages of the same tenor as the above message.

It should be noted that a portion of the above message is a variable portion which is the name of the subject of the birthday. That is, the variable portion may, for example, be the name selected by the user or the user's name. This variable portion is selected based on data pertinent to the birthday.

For example, data registered by e.g., the user by another application software may be adaptively used.

That is, there are occasions where various data pertinent to a user are incidentally stored as a database in the personal computer 100 by another application software. The various data mean birthdays, names etc of user or of related persons. The application software of the diary function adaptively uses birthday data, such as birthdays or names, registered as such database, to select the message. By selecting the message by such technique, messages can be displayed on the user's birthday even if birthday data has not been entered in the course of execution of the application software having the diary function. In such case, the user who actually has not input the relevant data will be surprised to see the message concerning his or her birthday.

The birthday data of the robot apparatus 1 is stored in the memory card 28 and used in the message selection. For example, the robot apparatus 1 leaves a boot date time log on first booting following its purchase. The date/time is used as birthday data.

The messages of the birthday-related group are provided as described above and the variable part is selected based on the birthday data so that the message with the so selected variable part is displayed in the diary picture. Since there are plural messages in the birthday-related group, one of them is selected at random and displayed. This prevents the message of the same group from being repeatedly displayed on the birthday.

As the birthday-related messages, messages can also be displayed on a day other than the birthday, such as one week before, three days before, on the directly previous day, or on the next day. The messages shown in the following table:

| | patterns provided as predictive messages of the |
|---|---|
| time | birthday-related group for other than the birthday |
| one week before | birthday for (variable part) is nearing |
| three days before | birthday for (variable part) is impending |
| directly previous day | to-morrow is the birthday for (variable part) |
| next day | yesterday was the birthday for (variable part) |

This allows the birthday-related messages to be displayed on other than the birthday. Meanwhile, the message provided as a message for one week before the birthday is displayed on any day in a time period from a day four days before the birthday until one week before the birthday. The same may be said of the message three days before.

(3-3-2) Messages of the Anniversary-related Group

This anniversary-related group is selected when there are anniversary data. The display messages, provided as the anniversary-related group, may, for example, be ‘to-day is an anniversary for (variable portion)’. In the group of the anniversary-related messages, there are plural sorts of messages of the same tenor as the above message.

The anniversary may be classified into one proper to a user and a common anniversary, for example, the national anniversary. Thus, the anniversary may be classified into one in need of the variable part for the appellation given the robot by the user or the user's appellation and one not in need of the variable portion. So, the messages provided are classified, depending on whether or not there is the variable part, as shown by the following Table:

examples of anniversaries with variable part

birthday (as separated from the anniversary given previously
marriage anniversary
day of secrecy
day of personal significance
day of remembrance
day of promise
day of farewell

examples of anniversaries without variable part

New Year's Day
Christmas
doll's festival
children's day
day of respect for the aged
father's day
mother's day
Valentine's day

As for the variable part, the following display, for example, may be used:

display patterns of subject's names of the anniversary-related group

all
myself
father
mother
grand father
grand mother
‘name’

The various messages are provided as they are classified as described above. The message is selected, based on anniversary data, the variable part, if necessary, is also selected, and the message is ultimately displayed on the diary picture. Since there are also plural messages in the anniversary-related group, one message is selected at random and displayed.

As for the data for selecting the message or the variable part, data registered by the user on other opportunities are adaptively used, as described in connection with the birthday-related group.

The messages can also be displayed on a day other than the anniversary, as in the birthday-related message group described above. The messages shown in the following table:

| | patterns provided for predictive anniversary group |
|---|---|
| time | messages for days other than the anniversary |
| one week before | anniversary of (variable part) is nearing |
| three days before | anniversary of (variable part) is impending |
| directly previous day | to-morrow is anniversary of (variable part) |
| next day | yesterday was anniversary of (variable part) |

This enables messages concerning the anniversary to be displayed for days other than the anniversary.

(3-3-3) Messages of the Growth Date Group

The growth day group is selected in case growth data are available. Among the messages provided for the growth date group is a message reading: ‘today I'm one year older’. In the growth date group, there are plural sorts of the messages of the same tenor as this message.

The robot apparatus 1 has a growth model which is changed through several stages from an infant stage to the adult stage. The robot apparatus performs the behavior depend on the growth stages. In the robot apparatus 1, data of the above growth stages are stored in the memory card 28. In the growth date group, the stage change information concerning the growth stage, as stored in the memory card 28, is referenced and a corresponding message is selected. The so selected message is displayed in the diary picture. Since there are plural messages in the group of the growth date group, one of the messages is selected at random and displayed.

Plural messages of the growth date group are provided depending on the respective growth stages. Thus, when the growth state has proceeded to the next stage, and the fact of growth is indicated in the message, messages of different expressions are displayed depending on whether the new stage reached is the stage of a child or that of an adult.

(3-3-4) Message of the Group of the Input/output Semantics

The input/output semantics renders the information input to or output from the robot apparatus 1 the information that can be interpreted by the user, such as recognition information. For example, the information that can be interpreted by the user is the information such as ‘being patted’ or ‘being stroked’ as interpreted based on the exterior information, or the information such as ‘ball kicked’ or ‘hand touched’ which may be interpreted as the own behavior. Thus, the message of the input/output semantics is based on the user interpretable information. The input/output semantics are data updated in the robot apparatus on the memory card 28.

Examples of the messages provided as being of the input/output semantics include ‘(input/output semantics) made’ by (user's name) at (time-variable portion)’, and ‘to-day, please do many (output semantics)’.

Since the input/output semantics can basically be adopted several times a day, those messages are provided in which the time zones are variable. The display of the time variable part may be exemplified by time-based display as indicated by the following Table:

| time zones | display patterns |
|---|---|
| 4:00 to 10:00 as time zone 1 | ‘morning’ |
| 10:00 to 16:00 as time zone 2 | ‘daytime’ |
| 16:00 to 22:00 as time zone 3 | ‘night’ |
| 22:00 to 4:00 as time zone 4 | ‘midnight’ |
| time astride time zones 3 and 4 | ‘night’ |

If a time zone other than those tabulated is at issue, for example, if a time zone straddles plural time zones, such as time zones 1 to 3, such time zone may be treated as ‘to-day’, with the time variable part not then being displayed.

Also, messages provided are pre-classified into those having variable portions and those not having variable portions. In case of semantics having the variable portions, messages having the display for the variable portion and those not having the display for the variable portion are provided. For each of the semantics, plural types of the messages of the same tenor are provided.

Since the robot apparatus 1 has many input/output semantics, it is also possible to select candidates for semantics displayed as messages. For example, since an input/output log and the boot time are acquired for the input/output semantics, the occurrence frequency per unit time, such as quotient obtained by dividing by time the number of times of booting derived from the input/output log, is calculated, and such input/output semantics in which the quotient has exceeded a preset threshold is adopted as a candidate. It is noted that the preset threshold value is provided for each semantics being selected.

If the number of candidates of the input/output semantics exceeds the maximum number of messages that can be displayed in the diary picture, five in the present embodiment, candidates are further wine-pressed. For example, a number of the candidates equal to the maximum number of the messages that can be displayed are selected at random by way of wine-pressing the candidates.

Since there are occasions where several messages of the groups of the higher priority order are already decided to be displayed, the candidates are wine-pressed to a number equal to the number of the remaining messages that can be displayed.

The messages of the groups of the input/output semantics are provided as described above and the messages are selected based on the semantics stored in the memory card 28, occasionally the semantics resulting from the wine-pressing selection, with the messages so selected being then displayed on the diary picture. Since plural messages are provided in the same semantics, one of these is selected at random and displayed.

If the messages corresponding to the semantics are selected as described above but the number of the messages so selected is not up to the number of display pictures, herein five, the messages provided in the type change group at the adult stage, growth group, instinct group etc, of the lower priority order, are selected, and displayed in the diary picture.

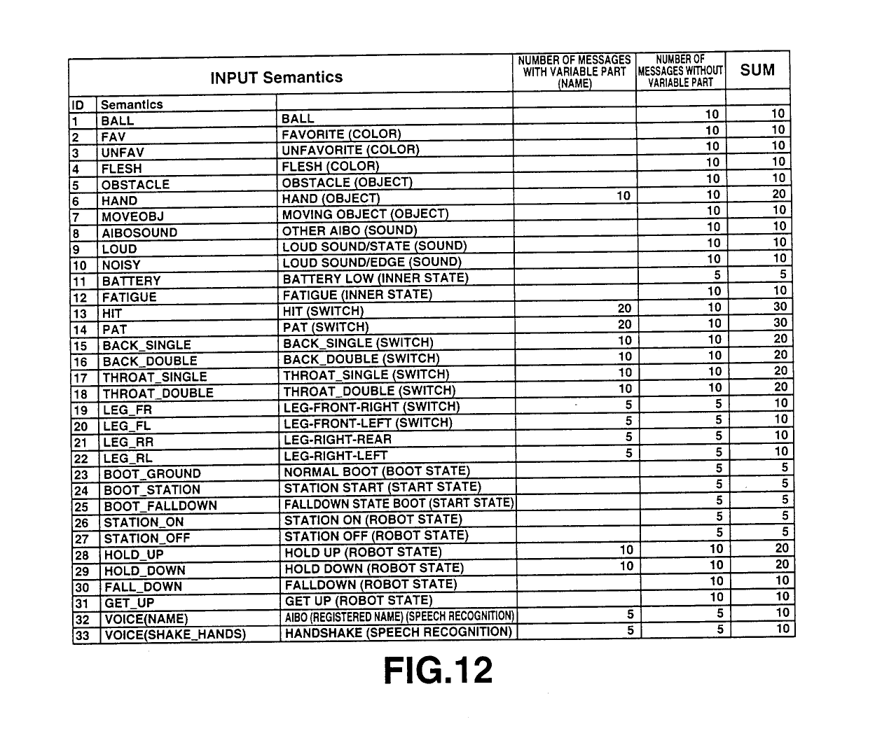

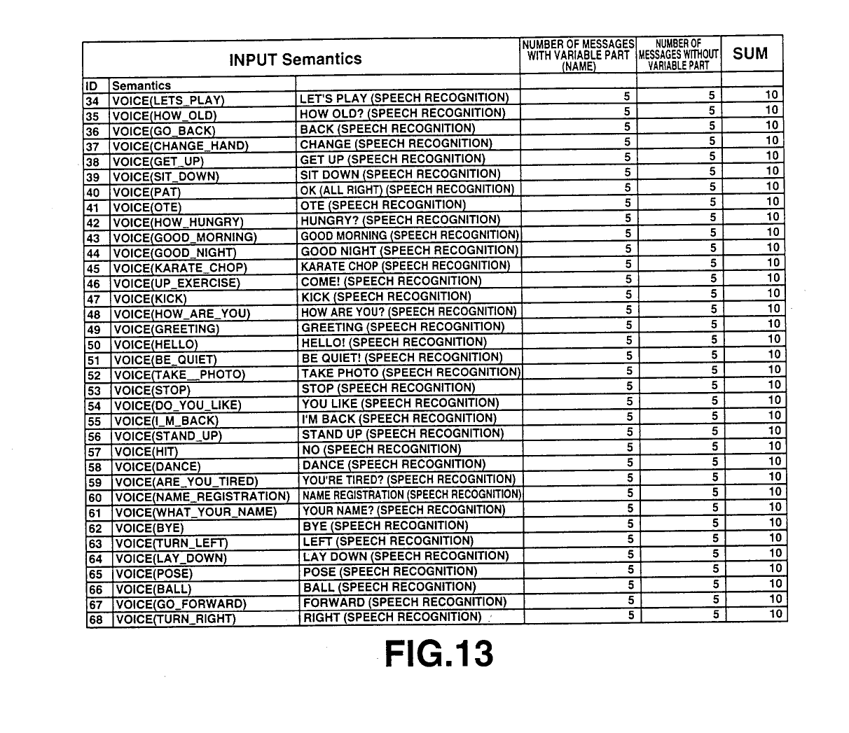

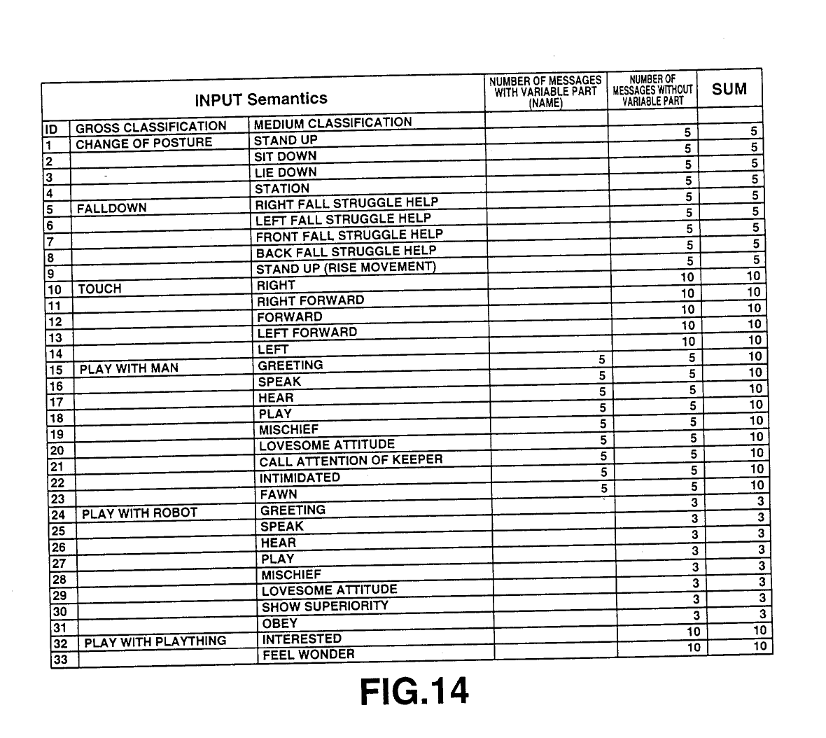

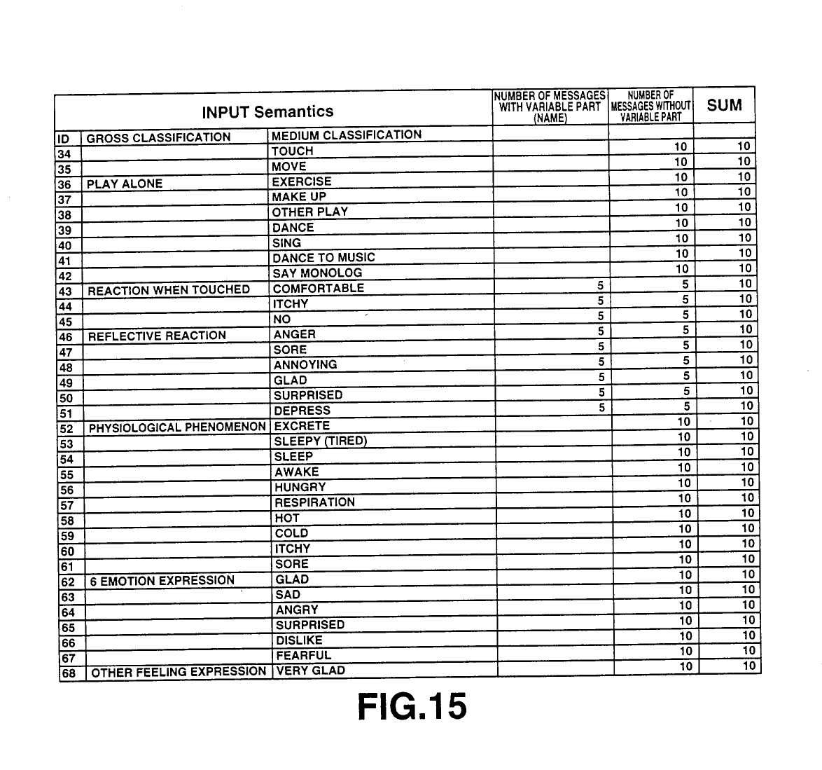

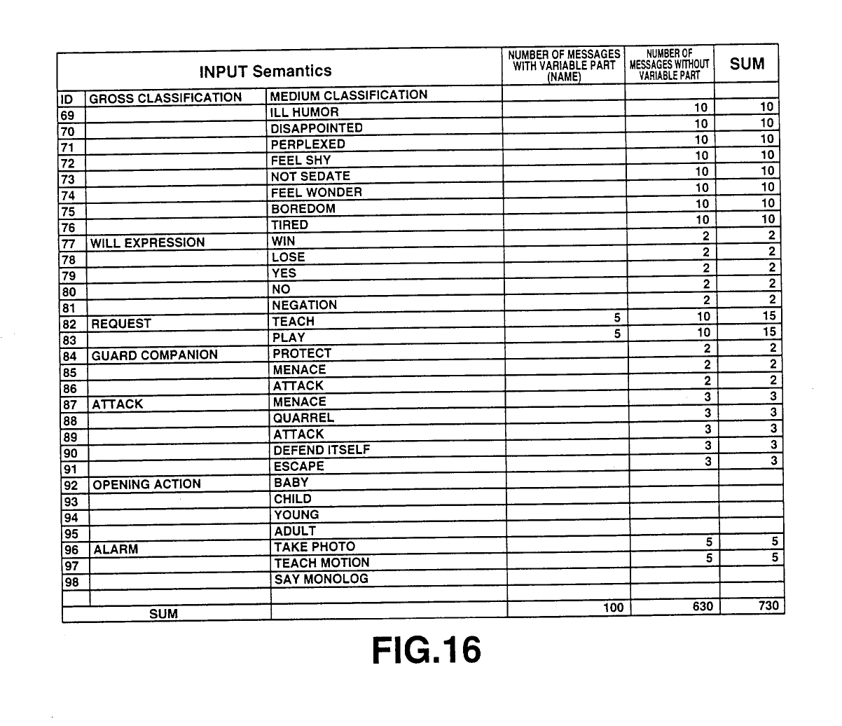

Specifically, there are provided input/output semantics of the contents shown in FIGS. 12 to 16. Moreover, plural messages are occasionally provided for each of certain input/output semantics, as shown in FIGS. 12 to 16.

(3-3-5) Messages of the Type Change Group in the Adult Stage

The type change in the adult stage is the type change in the same growth stage. The robot apparatus 1 is changed in its type, such as character, at a certain growth stage, and is adapted to behave depending on the so changed type. The type change in the adult stage is the type change in this same growth stage and is what may be called the transverse growth change. It follows from this that the aforementioned growth date group refers to what may be called the longitudinal growth.

In the robot apparatus, the type in the adult stage is stored in the memory card 28. The type change group in the adult stage is selected by referencing the types stored in the memory card 28 and the corresponding message is selected.

Among the messages provided as the type change group in the adult stage, there is such a message reading: ‘I'm older to-day by one year’.

The messages of the type change group in the adult state may be provided depending on the growth stages. By this, the contents indicating the growth may be displayed as the messages made up by different expressions.

(3-3-6) Messages of Feeling and Instinct Groups

Among the messages provided as the feeling and instinct groups, there is, for example, such a message reading: ‘To-day, I've been sleepy all day long’. The robot apparatus 1 selects the message depending on the feeling state, instinct state, awakened state, or on the degree of the interaction. The feeling, instinct, awakened state or the interaction degree are data updated by the robot apparatus on the memory card 28. Based on these data, stored in the memory card 28, the groups of the feeling and instinct groups and the message are selected.

On the other hand, the robot apparatus 1 has the feeling constructed by plural emotion types, while the instinct is constituted by the plural desires. Thus, if the messages is selected simply based on changes in the plural emotion types, plural desires, awakened states and interaction degrees, plural messages will be selected. In this consideration, these values are selected at a preset time interval, such as at an interval of 15 minutes, and candidates are first selected on averaging the so selected values.

The candidates are selected by comparing the feeling, instinct, awakened degree or interaction degree, such as the average value thereof, to a preset threshold value. The threshold value is provided e.g., for a feeling as an object of comparison. The candidates are selected for each of a case where the measured value is lower than a lower threshold and a case where the measured value is larger than an upper threshold.

Moreover, if the number of the candidates has exceeded the maximum number that can be displayed, herein five, the candidates are wine-pressed further. For example, the maximum number of messages that can be displayed is selected at random to wine-press the candidates.

Since there are occasions where a certain number of candidates are determined to be displayed from the group of the higher priority rank, this is taken into consideration, so that the number of the remaining candidates that can be displayed are selected at random.

The messages of the feeling and instinct groups are provided as described above and the messages are selected based on the feeling state, instinct state, the awakened state or the interaction degree, occasionally further wine-pressed and selected as candidates. The messages so selected are displayed on the diary picture. Since plural messages are provided for the same tenor, one message is selected at random and displayed.

(3-3-7) Other Messages

Among other messages, there are, for example, such messages reading: ‘To-day there was nothing that occurred’, or ‘I want to be strong since I was born as a robot’. These messages are provided for such a case where the data used for the above-mentioned respective cases could not be acquired. In this manner, messages can at least be displayed on the diary picture even if there is no changes in the robot apparatus itself or in the surrounding state. Moreover, a number of messages equal to the display number are displayed at random.

A group is selected, a message is selected in the so selected group and occasionally a variable portion is selected in the message until finally a diary picture containing the message is displayed on the monitor 101, as shown in FIG. 10. This enables the user to have a dialog with speech with the robot apparatus 1.

(3-4) Acquisition of a Picture in the Robot Apparatus 1

In addition to writing as message in the above-described diary, the robot apparatus 1 is able to attach a picture. Here, the acquisition of the attached picture is concretely explained. For example, a case of acquiring the image pickup information depending on the feeling state is explained, as an example.

The robot apparatus 1 has parameter values of emotion types of the feeling model changed depending on the surrounding states and on inner states and acquires the photographed image in the following manner depending on these values. The emotion types of the feeling may be enumerated by, for example, ‘joy’, ‘fear’ and so forth. The robot apparatus 1 acquires the photographed image based on, for example, the parameter value ‘fear’.

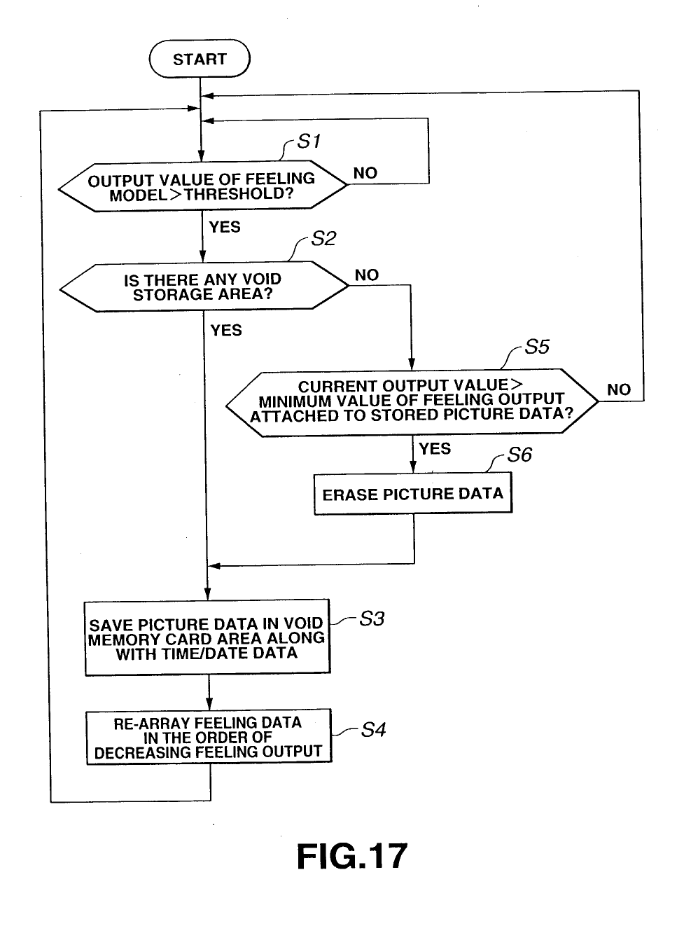

Referring to FIG. 17, the CPU 10 at step S1 checks whether or not an output value of the feeling model 73 (feeling parameter) has reached a preset threshold value. If it is determined at step S1 that the output value of the feeling model 73 has not exceeded the preset threshold value, the CPU 10 reverts to step S1. If it is determined at step S1 that the output value of the feeling model 73 has exceeded the preset threshold value, the CPU S2 proceeds to step S2.

At step S2, the CPU 10 checks whether or not there is any vacant storage area in the memory card 28. If it is determined at step S2 that there is vacant area, the CPU 10 proceeds to step S3 to store the picture data captured from the image pickup device 20 in the vacant area of the memory card 28. At this time, the CPU 10 causes date and time data and the feeling parameter, as the characteristic information of the picture data, in association with the picture data.

At step S4, the CPU 10 re-arrays the photographed pictures in the order of the decreasing output values of the feeling model 73. The CPU 10 then reverts to step S1. That is, the storage area of the memory card 28 is made up by a header 111, which holds the date and time information and feeling parameters, as characteristic information, and a picture data unit 112, which holds the characteristic information. The CPU 10 sorts the photographed picture data in the order of the decreasing parameter values of the feeling parameters.

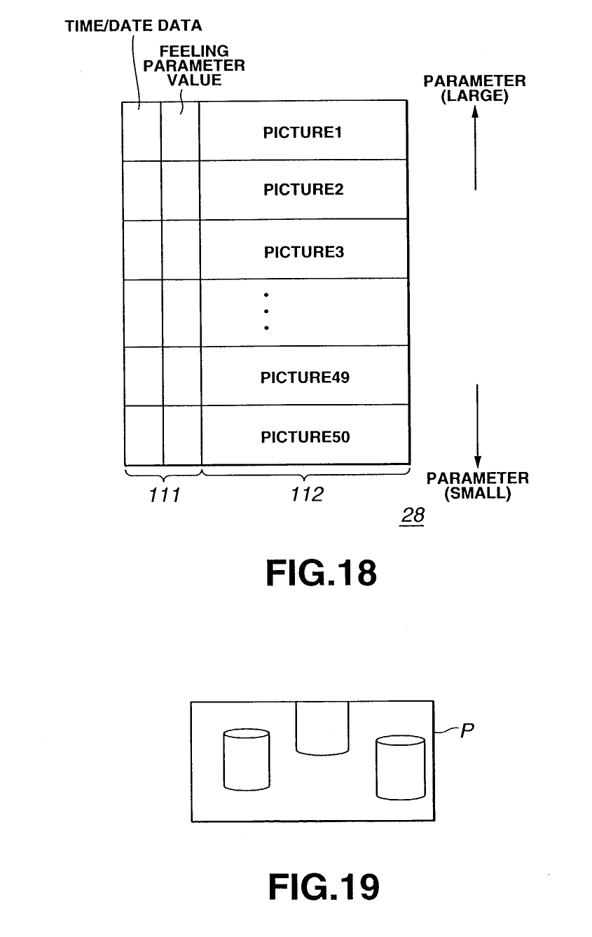

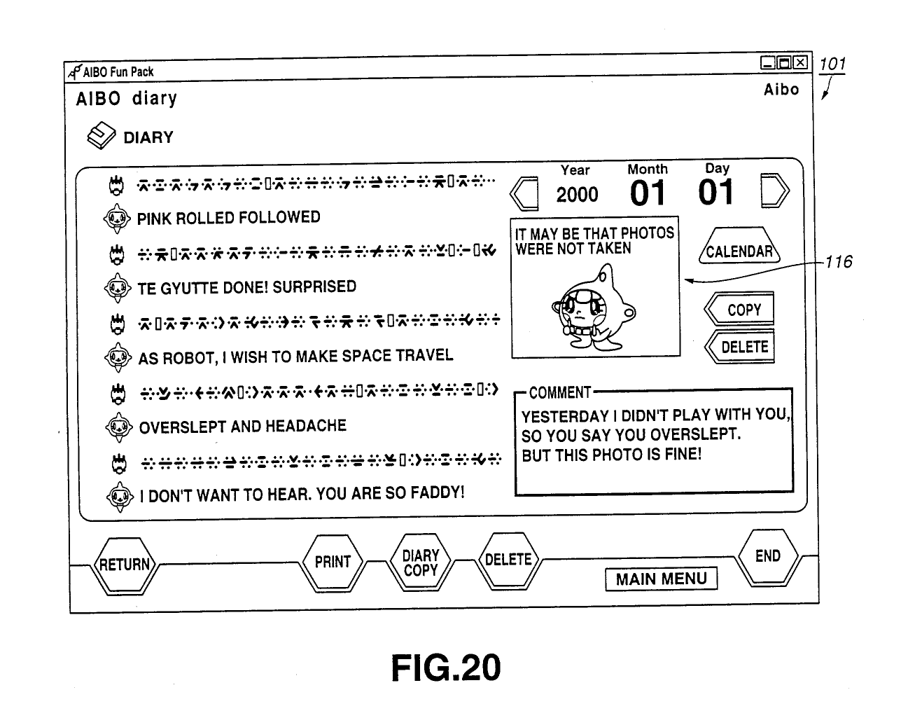

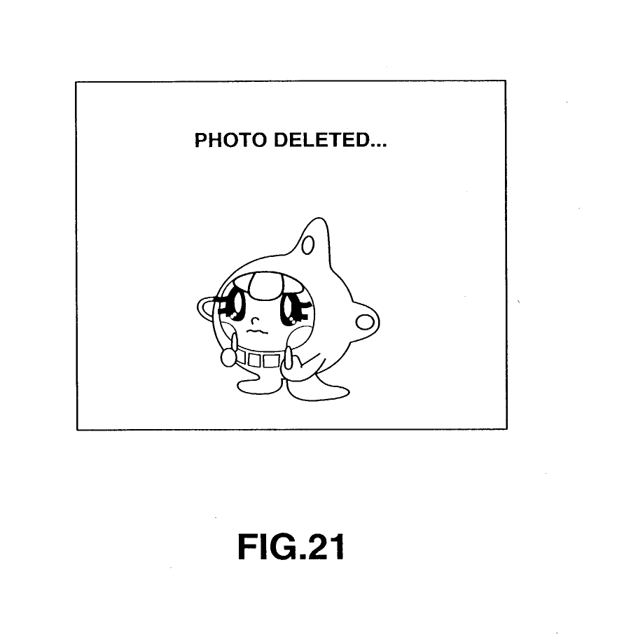

If it is determined at step S2 that the storage area is not vacant, the CPU 10 proceeds to step S5, where the CPU checks whether or not the current output value of the feeling model 73 is larger than the smallest feeling parameter value associated with photographed picture data stored in the memory card 28. That is, it is checked whether or not the current output value of the feeling model is larger than the feeling parameter value arrayed at the lowermost portion of FIG. 18. If it is determined at step S5 that the current output value is not larger (that is smaller) than the smallest feeling output value as stored, the CPU reverts to step S1.

If it is determined at step S5 that the current output value is larger than the smallest feeling parameter value as stored, the CPU 10 proceeds to step S6 where the CPU 10 erases picture data corresponding to the smallest feeling parameter value.

The CPU then proceeds to step S3 to store the prevailing feeling parameter value. This causes the feeling parameter values in the order of the decreasing parameter values in the memory card 28.

By the above processing, the robot apparatus 1 is able to refer to the feeling information of the feeling model to cause the picture data to be stored in the memory card 28 operating as storage means. This enables the personal computer 100 to display the picture having the largest parameter value among the pictures stored in the memory card 28 in the diary picture where there are already displayed various messages described above. This causes the photographed picture P, shown in FIG. 19, to be displayed in the diary picture. The photographed picture, shown in FIG. 19, is a picture in which the robot apparatus feels fear for an obstacle lying before it, such as a sofa, such that the parameter value of the emotion type of the feeling has assumed a maximum value.

In the foregoing embodiment, acquisition of the picture data based on the feeling model parameter values has been explained. However, the present invention is not limited thereto. For example, picture data can also be acquired based on, for example, instinct model parameter values, or on data relevant to the values of stimuli applied from outside.

Moreover, the photographed pictures are not necessarily available. In such case, a character looking like human being is displayed in a location in the diary picture which should normally be occupied by the photographed picture, and a message by a character which reads: ‘it may be that photos were not taken’ is displayed. Meanwhile, the message by the character may also be such a message which reads: ‘photos are deleted here’.

In the above-described embodiment, the case of using the memory card 28 as a data transfer medium to the personal computer 100 has been explained. However, the present invention is not limited to this configuration. The robot apparatus 1 and the personal computer 100 may be interconnected by wired or wireless communication means, in which case the personal computer 100 may execute the diary function based on the data transmitted from the robot apparatus via such communication means.

Although the diary picture or messages for implementing the diary function have been specifically explained in the foregoing, the present invention is not limited to this configuration.

Moreover, in the foregoing embodiment, the birthday-related or anniversary-related groups have been given as the message grouping examples. However, the present invention is, of course, not limited to this configuration.

Moreover, in the above-described embodiment, the messages forming the diary contents may also be constructed as the database. Alternatively, such database may also be downloaded from, for example, the Internet. Since this enables the contents of the pre-existing database to be updated by data present on the net to enable an untiring diary to be produced.

Moreover, in the above-described embodiment, the image pickup timing for a picture to be introduced into diary contents is based on e.g., the feeling. The present invention again is not to be limited to this configuration since a speech command from a user may also be used as an image pickup timing.

### INDUSTRIAL APPLICABILITY

In accordance with the present invention, described above, the robot apparatus is able to transfer the information it has acquired to e.g., an information processing apparatus in an information display unit of which a document is demonstrated based on the acquired information. In this manner, the user is able to have a dialog with speech with the robot apparatus.

1. A robot apparatus in which the information acquired is displayed in an information display device, said apparatus comprising:
information acquisition means for acquiring the information adapted for being demonstrated in said information display device; and
information transfer means for transferring the information acquired by said information acquisition means to said information display device.

2. The robot apparatus according to claim 1 wherein said information display unit is an information processing device having a display unit.

3. The robot apparatus according to claim 1 wherein said information acquisition means acquires the information from outside.

4. The robot apparatus according to claim 3 wherein said information acquisition means is image pickup means.

5. The robot apparatus according to claim 1 wherein said information acquisition means acquires the information from inside.

6. The robot apparatus according to claim 5 wherein the robot apparatus behaves based on a feeling state changed with the external information and/or with the inner state, and wherein said information acquisition means acquires said feeling state as said inner information.

7. The robot apparatus according to claim 5 wherein the robot apparatus behaves based on an instinct state changed with the external information and/or with the inner state, said information acquisition means acquiring the instinct state as said inner information.

8. The robot apparatus according to claim 5 wherein the robot apparatus behaves based on a growth state changed with the external information and/or with the inner state, said information acquisition means acquiring the growth state as said inner information.

9. The robot apparatus according to claim 5 wherein the robot apparatus behaves autonomously, said information acquisition means acquiring the results of the autonomous behavior as said inner information.

10. The robot apparatus according to claim 1 wherein the information transfer means is removable external storage means; and
wherein said external storage means having stored therein the information acquired by said information acquisition means, and said information display device displaying the information based on the information thus stored in said external storage means.

11. An information displaying system comprising:
a robot apparatus including information acquisition means for acquiring the information and information transfer means for transferring the information acquired by said information acquisition means; and
an information processing device for displaying a sentence in an information display unit by exploiting a sentence pattern, provided from the outset, based on the information acquired by said information acquisition means and transferred by said information transfer means.

12. The information displaying system according to claim 11 wherein said information processing device displays the language proper to the robot's world, provided from the outset, in said information display unit, in conjunction with said sentence, based on the information acquired by said information transfer means.

13. The information displaying system according to claim 11 wherein said information processing device displays on said information display unit a human character or an animal character behaving responsive to the information displayed on said information display device.

14. The information displaying system according to claim 11 wherein said information processing device also adaptively uses the information on the database it owns to display the sentence on said information display unit by exploiting the sentence pattern provided from the outset.

15. The information displaying system according to claim 11 wherein said information processing device provides a plurality of sentence patterns classified into a plurality of groups having the priority order attached thereto; and
wherein said information processing device selects the groups based on the information acquired by said information transfer means and said priority order and displays the sentence in said information processing unit by exploiting the sentence pattern in said group.

16. The information displaying system according to claim 15 wherein said groups are those related at least with the birthday, anniversary, growth, input/output information of the robot apparatus, personal character and feeling/instinct of the robot apparatus; and
wherein the priority order attached to said groups is the birthday, anniversary, growth, input/output information of the robot apparatus, personal character and feeling/instinct of the robot apparatus, arranged in the ranks of decreasing priority.

17. The information displaying system according to claim 11 wherein said information acquisition means acquires the information supplied from outside to the robot apparatus.

18. The information displaying system according to claim 17 wherein said information acquisition means is image pickup means; and
wherein said information processing device displays the image picked up by said image pickup means on said information display unit.

19. The information displaying system according to claim 11 wherein said information acquisition means acquires the inner information of the robot apparatus.

20. The information displaying system according to claim 19 wherein said robot apparatus behaves based on a feeling state changed responsive to the external information and/or inner information; and
wherein said information acquisition means acquires the feeling state as said inner information.

21. The information displaying system according to claim 19 wherein said robot apparatus behaves based on an instinct state changed responsive to the external information and/or inner information; and
wherein said information acquisition means acquires the instinct state as said inner information.

22. The information displaying system according to claim 19 wherein said robot apparatus behaves based on a growth state changed responsive to the external information and/or inner information; and
wherein said information acquisition means acquires the growth state as said inner information.

23. The information displaying system according to claim 19 wherein said robot apparatus behaves autonomously; and
wherein said information acquisition means acquires the results of the autonomous behavior as said inner information.

24. The information displaying system according to claim 11 wherein said information transfer means is removable external storage means;
wherein said robot apparatus holds the information, acquired by said information acquisition means, in said external storage means; and
wherein said information processing device displays a sentence in said information display unit, based on the information stored in said external storage means, by exploiting the sentence pattern provided from the outset.

25. A method for displaying the information comprising:
acquiring the information by a robot apparatus; and
displaying the sentence in an information display unit of an information processing device, based on the information as acquired by said robot apparatus, by exploiting the sentence pattern provided from the outset.

26. A robot system comprising a robot apparatus, which behaves autonomously, an information processing device for processing the information pertinent to said robot apparatus, and picture display means for displaying the contents relevant to the information processed by said information processing device, wherein said robot apparatus includes information acquisition means for acquiring the activity information relevant to activities of said robot apparatus and storage means for storing the activity information acquired by said information acquisition means;
wherein said information processing means including message pattern storage means holding a plurality of messages or sentences and diary forming means for forming a diary relevant to said robot apparatus; and
wherein said picture display means displaying said diary formed by said diary forming means.

27. The robot system according to claim 26 wherein said message pattern storage means is set on the Internet.

28. The robot system according to claim 26 wherein said activity information includes the picture information; and
wherein said diary being made up by said messages or sentences and said picture information.

29. An information displaying method comprising:
acquiring the activity information relevant to activities of a robot apparatus, behaving autonomously, by said robot apparatus; and
forming a diary relevant to said robot apparatus, by an information processing device, based on a plurality of messages or sentences in message pattern storage means, holding said messages or sentences, and on said activity information, for display on picture display means.

30. A computer-controllable recording medium having stored thereon a program for forming a diary relevant to an autonomously behaving robot apparatus from the activity information relevant to activities of said robot apparatus and from plural messages or sentences.
